(19) United States
(12) Patent Application Publication
(10) Pub. No.: US 2010/0180821 A1
(43) Pub. Date: Jul. 22, 2010

(54) Device With Drivable Means For Injecting A Fluid Substance Into An Egg And Equipment Including Same

(76) Inventors: Raphaël Poulard, Plourin les Morlaix (FR); Jean-Pierre Breuil, Authon (FR); Robert Croguennec, Milizac (FR)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/532,932

(22) PCT Filed: Mar. 25, 2008
(86) PCT No.: PCT/EP08/53492

§ 371 Date: Feb. 12, 2010

(30) Foreign Application Priority Data
Mar. 28, 2007 (FR) 07/02286

(51) Int. Cl. A01K 45/00

(52) U.S. Cl. 119/6.8

(57) ABSTRACT

The invention relates to a device for injecting at least one fluid substance into an egg, of the type that comprises an injector body equipped with a protruding piercing needle for injecting said substance into the amniotic liquid of said egg and/or into the embryo contained therein, the body being connected with external means for supplying said substance, characterized in that drivable means are integrated in the body for expelling towards said needle one or more adjustable variable and parametered amounts of substance from said supply means. The invention also relates to equipment including a plurality of such devices.

The present invention relates to a device to inject at least one fluid substance, such as a vaccine, into an egg.

It also relates to an installation comprising a plurality of said devices.

By “fluid substance” is meant a substance which has the capability of flowing under the effect of its own gravity. This therefore encompasses liquid materials, viscous materials but also particles in suspension in a liquid.

It is well known to inject treatment substances into eggs, in particular vaccines to limit mortality rate and/or to increase the growth of the embryos contained therein, and/or to prevent certain risks of infectious diseases which could affect the embryo.

Said devices essentially comprise a series of needle injection heads, mobile vertically above a conveyor transporting incubation trays and/or any type of dimpled support on which the eggs are placed.

For injection, the injection instrument assembly is moved from a raised position to an injecting position intended to cause the injectors to bear against the eggs using positioning means containing the injection needle (or syringe). The needles of the injectors are then moved from an upper position to a lower injection position, to inject the substance into the eggs.

In document EP 1505870 an injection device is described, in which the substance to be injected is placed under very high pressure (5 to 50 bars). The pressure of the substance is then used to pierce the inner membrane of the egg, to allow said substance to enter into the amniotic liquid. This technique has serious drawbacks, since the pressure withstood by the substance destroys the molecules of the living organisms contained in the substance.

This same document describes an injection device in which the substance, for example a vaccine, is brought from outside to inside the body of the injector, into an injection chamber.

This chamber is filled and emptied under pressure by means of a piston actuated by a single- or double-acting pneumatic cylinder.

It is therefore possible to deliver a predetermined, precise, constant quantity of substance e.g. 0.2 ml.

When use is made of a device such has just been described above, it can be considered that the volume of the injection chamber is invariant during the operating mode.

The volume of this chamber can only be changed by modifying the stroke of the piston, which can only be made when the machine is stopped, and requires either modification of the geometry of the chamber parts through the addition of a filler piece, or machining, or the installation of a new set of injectors corresponding to the desired volume.

The complex, costly nature of such operations can be imagined, together with the tedious aspect and the practical difficulties which consequently arise. To the practical difficulties just mentioned must be added the manual handling of the injector assembly to prime entry of the substance to be injected.

Also, it is important to recall that the eggs collected from their breeding place to be placed on dimpled supports in which each egg occupies a separate compartment, may derive from different varieties. Great diversity is noted in the size of the eggs, irrespective of the genetic variety.

Batches of eggs are systematically heterogeneous. On this account, the dimpled trays contain eggs of different sizes (generally the eggs fall into four categories: large, medium, small and very small), the proportion of each category in each tray being variable and fully random.

The eggs are therefore a “mix” of different sizes. Yet, it is possible that a different volume of substance is to be injected for each egg size present on the dimpled support.

It is ascertained that the device described above cannot meet said requirement.

Conventional injection devices use diaphragm pumps or peristaltic pumps which are placed between the external source of the substance to be injected and the injectors. This entails a tubular link between each pump and each injector.

Also, an installation of this type frequently has several tens of injection devices. The number of tubes placed in its environment is therefore very high, which may in particular cause problems of access, of cleaning and maintenance for some parts of the installation. And this problem is further aggravated if it is desired to inject several different products in one same injection.

It is also ascertained that the type of pump mentioned above meets the need to deliver a specific volume of substance to be injected, but it does not allow the dispensing of different volumes of substance. This gives rise to difficulty when it is required to vary the quantity of substance to be injected.

However, a problem nevertheless remains as to the type of treatment product to be injected when it concerns a vaccine.

Vaccines effectively contain living organisms which relatively ill withstand mechanical stresses, pressure and speed. Yet with the system just described not only is there an entire network of tubing between the storage container and the expelling means, but also a tube between each expelling means and each injection device. It will be appreciated that the “pathway” followed by the liquid from the container to an injection device is lengthy, and that this liquid is therefore submitted to a particularly high number of stresses which may affect its quality.

Another drawback is related to the fact that the tubes consist of a flexible material which deteriorates rapidly, which means that they need to be frequently replaced.

A further disadvantage is related to the fact that the quantities of substance to be delivered are difficult to control through the use of flexible tubes. A quantity that is more than necessary is injected to ensure that the amount of active ingredient administered is sufficient.

Yet another disadvantage can be cited, namely the difficult cleaning and disinfection of the entire tubing system.

The invention therefore sets out to overcome these drawbacks by proposing a device with which it is possible to reduce to a minimum the stresses to which the substance is subjected, whilst freeing the immediate vicinity and meeting health constraints.

The invention sets out to meet the needs of volume variability of the substance to be injected automatically, using means integrated in the injector and using one same injector irrespective of these variability needs during the operating mode.

The invention also sets out to use low pressure to deliver the substance via a needle into the amniotic liquid or into the embryo, so as not to destroy the living organisms forming the substance.

Finally there is a demand for an adjustable length of needle penetration into the egg in relation to the genetic varieties and age of the egg batches.

However the devices currently on the market are not able to meet this function.

The invention also sets out to meet this shortcoming.

The invention therefore relates to a device to inject at least one fluid substance into an egg, of the type comprising an injector body provided with a projecting needle to pierce and to inject said substance into the amniotic liquid of said egg and/or into the embryo contained in said egg, this body being linked to external supply means of this substance.

According to the invention, drivable means are integrated in said body to expel towards the needle one or more adjustable, variable and parameterizable quantities of substance derived from said supply means.

By “substance” is meant both a single product and a mixture of different products, contained for example in different supply means.

By “this body houses” is meant that it contains or integrates these drivable means. The drivable means are embedded in the injector.

Therefore, by integrating said expelling means inside the very body of the device, the entire assembly of is tubing eliminated which, in the prior art, was positioned between the external expelling means and each device. By so doing, the stresses on the substance are reduced whilst making the immediate vicinity of each device more accessible. The integration of these expelling means in said body also makes it possible, during the operating mode, to cause the volume of substance to be injected to vary in relation to the following non-limiting factors, for example: the size of the eggs, the age of the batches, the type of substance, the genetic variety, etc.

Also, according to other advantageous, non-limiting characteristics:

said drivable means consist of a variable volume electric micro-pump;

said drivable means consist of a miniature solenoid valve;

said body contains a cavity to house said means;

said body is linked to external supply means of at least two substances, so as to allow the successive or simultaneous injection of these substances;

said body is provided with electronic means to drive said expelling means;

said body comprises a slide which surrounds said needle longitudinally and is mobile between two end positions, namely a first position—called a rest position—in which it masks the entire length of said needle, and a second position—called a retracted position—in which it abuts said body thereby exposing at least part of said needle;

said body comprises an adjustable abutment whose positioning is used to cause variation in the penetration length of the needle into the egg;

the body comprises a sensor to control the functioning of the slide;

the slide is provided with a flexible suction cup able to adapt to the contour of the egg to hold it in injection position;

the slide is linked to means supplying disinfectant product.

The invention also concerns an installation to inject at least one fluid substance into eggs, which is noteworthy in that it comprises a plurality of devices according to any of the preceding characteristics.

In one particular embodiment, in which the eggs to be treated are positioned in dimpled trays arranged one after the other on conveying means, this installation comprises at least one group of devices aligned crosswise relative to the direction of travel of the conveying means, their mutual spacing being identical to the distance separating two adjacent dimples in said trays in the transverse direction.

Other characteristics and advantages of the description will become apparent on reading the following description of a preferred embodiment. This description will be made with reference to the appended drawings in which:

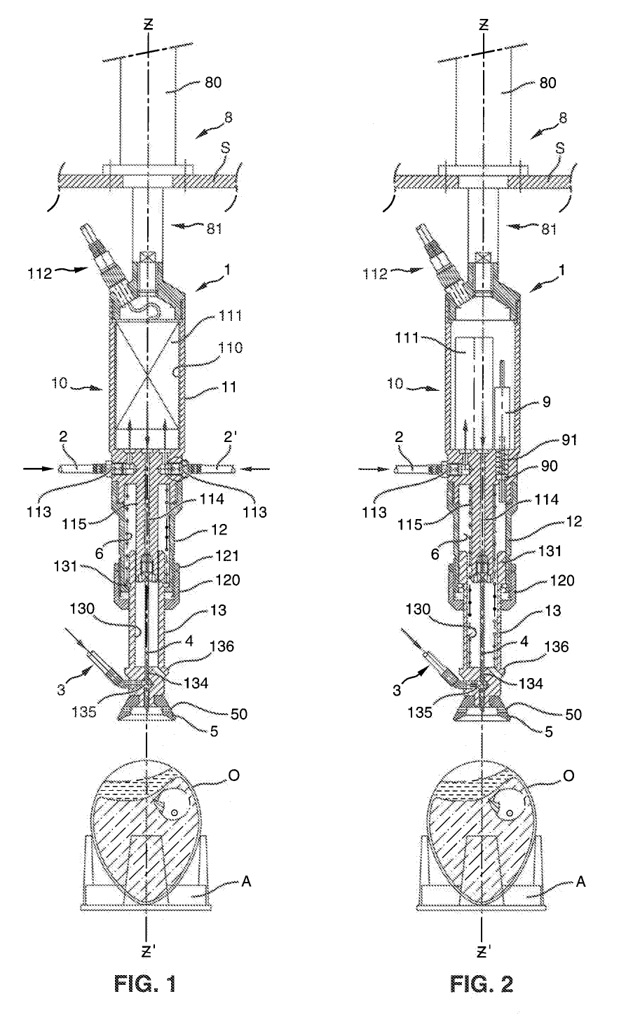

FIG. 1 is a cross-sectional view, along a median longitudinal plane, of a first embodiment of a device conforming to the present invention;

FIG. 2 is a similar view to FIG. 1, of a variant of embodiment of the device;

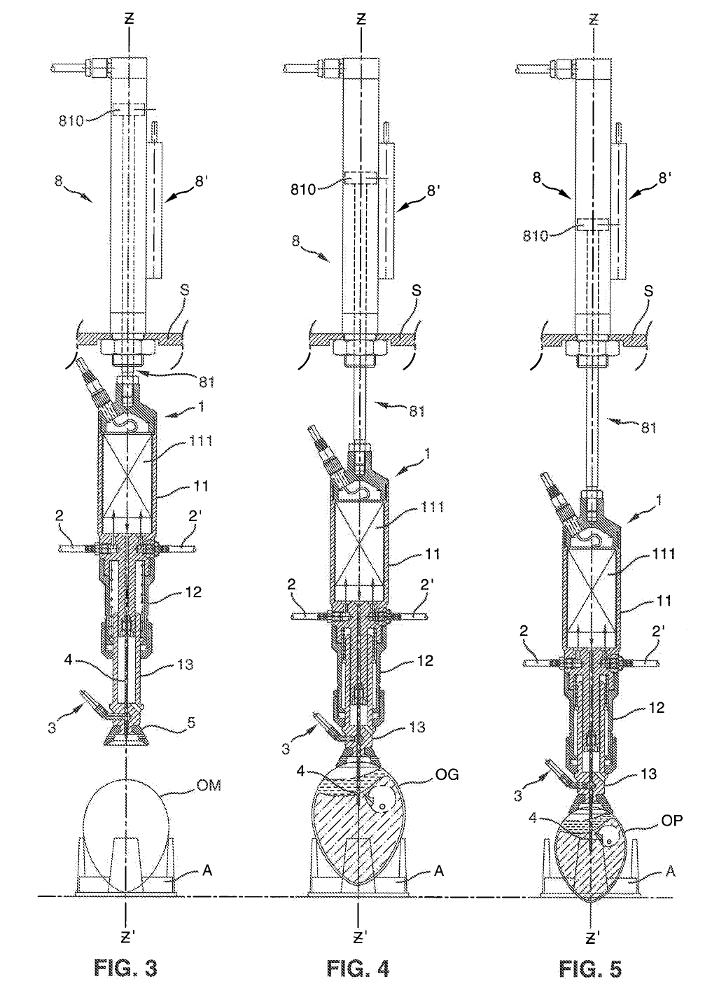

FIGS. 3 to 5 are similar views to FIG. 1 showing different positions of the device according to the invention, associated with identical displacement means and eggs of different calibres;

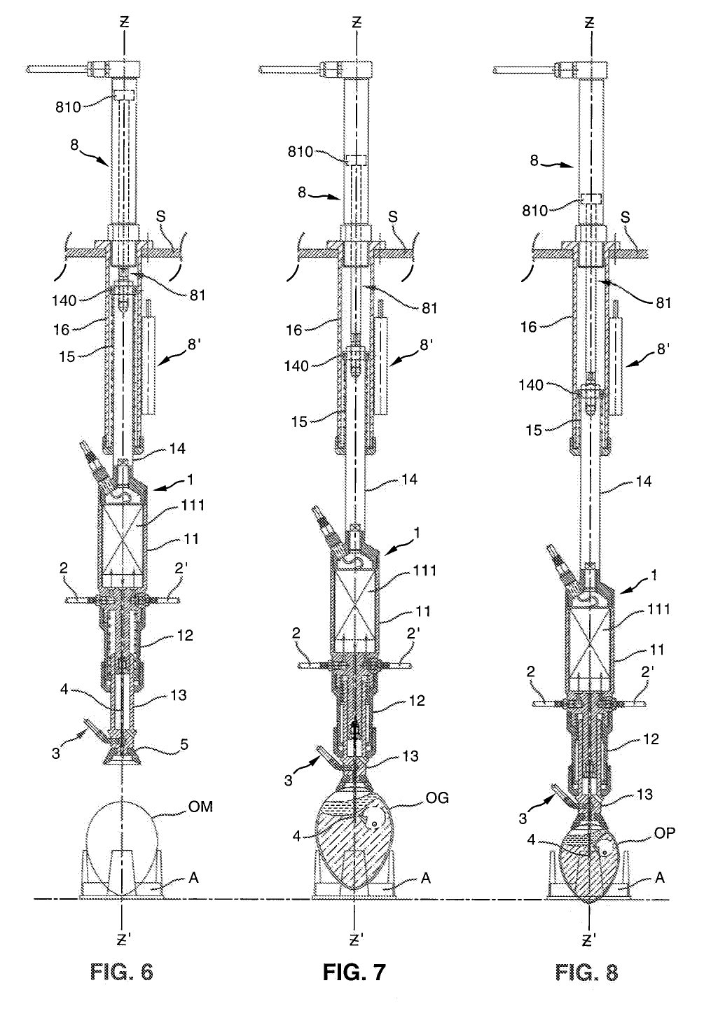

FIGS. 6 to 8 and FIGS. 9 to 11 are similar views to FIGS. 3 to 5, the displacement means illustrated being different.

The injection device shown FIG. 1 essentially comprises an injector body 10 provided with a projecting needle 4 to pierce and inject a fluid substance into an egg, this body being provided with a slide 13 which surrounds the needle 4 longitudinally and which, in the embodiment shown here, is partly housed inside the body 10.

This injector body is itself mounted on the free end of the rod 81 of a cylinder 8 of vertical axis ZZ′, which will be described further on.

The injector body 10 here consists of two elements, namely a main, generally cylindrical, sleeve 11 and a secondary skirt 12 which extends from the downward continuation of this sleeve.

Said sleeve 11 extends along axis Z-Z′. It is hollow and the vast recess it encloses forms a chamber used to house means 111 which are described later.

This sleeve 11 is extended downwardly by a cylindrical head 115 of small diameter, centred on axis Z-Z′, which forms a lower projection.

Along this head, also centred along axis Z-Z′, there extends a channel 114 which provides communication between the inner recess 110 and the free end of the head 115.

In the continuation of this channel there is a hollow needle or trocar 4, whose free end 40 is bevelled.

Two similar lines 2 and 2′ conveying substances to be injected are connected to the main sleeve 11 and communicate with the chamber 110.

More precisely, these lines are linked, via passageways 113, to said means 111. Evidently, when it is desired to inject a single substance, a single line 2 is sufficient.

The means 111 are drivable means to expel an adjustable quantity of substance through the channel 114 and the needle 4.

By “drivable” is meant that these are means used to adjust at will said quantity of substance to be injected, for example from outside the device without having to dismount the body of the device.

A first example of said drivable means consists of a variable volume electric micro-pump. Another example is a miniature solenoid valve. In this latter case, the line 2 (lines 2 and 2′) conveying the substance are linked to a pressurized container.

Examples of miniature solenoid valves which are fully suitable are those marketed by the LEE COMPANY under the name “bi-stable solenoid valve”.

Examples of micro-pumps which are fully suitable are those marketed by the LEE COMPANY under the name “variable volume pump”.

In particular, depending on the type of substance to be injected and its resistance to high pressures, preference is given to either one of these means.

At all events, they allow considerably wide pressure ranges from 0.01 bar for example up to more than five bars.

In FIG. 1, reference 112 identifies the power supply source for the drivable means 111 just described.

The means 111 can be associated with electronic driving means, also carried by the body 10, which will allow modification at will of the volume of liquid to be delivered. Said means are more amply described with reference to FIGS. 3 to 5.

In the extension of the lower end of the sleeve 11, a skirt 12 is mounted which extends parallel to axis Z-Z′ as far as below the head 115. This skirt forms a free annular space around this head.

On this skirt 12 an adjustable abutment 120 is mounted, equipped with a locking system 121 whose position can be changed.

As mentioned above, a slide 13 surrounds the needle 4. It is mounted mobile in translation with respect to the body 10, and more particularly with respect to the skirt 12.

Here the slide is joined to the inside of the skirt 1. For this purpose, its outer wall comprises a projecting peripheral ring 131 wedged against the lower bulbous end of the skirt 12.

The slide is hollowed inwardly over part of its length, namely the length directed towards its upper end. A helical spring 6 bears against the ring 131 and the bottom part of the annular space surrounding the head 115.

The spring 6 tends to bring the slide 3 back to the position in FIG. 1 i.e. the position in which it is in maximum withdrawn position from the body 10.

Along the remaining part of the slide and centred on axis ZZ′ there is a channel 134 which is used as housing for part of the needle 4. A line 2 conveying a disinfectant product leads into the slide body, this line communicating with the cavity 135 inside the channel 134 in the vicinity of the free end of the needle 4.

On the free lower end of the slide 13, a flexible suction cup 5 is mounted intended to follow the contour of the egg and to hold it in place at the time of injection. It consists of a highly deformable, non-aggressive product such as silicon. This specific suction cup is inserted on the end of the slide 13. A channel 50 can be seen FIG. 1 which is used to evacuate the air which may remain trapped between the suction cup and the egg at the time the suction cup is applied.

The slide 13 may move in translation between two end positions which can be seen more particularly FIGS. 1 and 4.

The first end position (FIG. 1) can be qualified as a “rest position”. In this position, the slide 13 masks the entire length of the needle 4 and its peripheral ring 131 bears against the lower end of the skirt 12. The expression bottom position may also be used.

In the second end position called the “retracted position” (the position in FIG. 4) a ring 136 projecting from the slide 13 bears against the adjustable abutment 120 so that it frees part of the needle 4.

It is noted that it is this freed part of the needle which determines its entry to a greater or lesser depth into the egg to be treated. Also, it is the positioning of the abutment 120 described above which determines the stroke of the slide 13.

The abutment 120 is adjusted by the operator, for example in relation to the “variety” of eggs to be treated, to the sharpening of the needle, so that the lower end of the needle through which the treatment substance is dispensed, is released into the amniotic liquid or embryo.

The device shown FIG. 2 has numerous points in common with the preceding device.

It differs however by the following points.

Firstly it is linked to only one line, 2.

In addition, the upper part of the slide comprises a projecting peripheral rim 131 which comes to lie against the ring of the skirt 12.

The spring 6 is placed in the longitudinal recess 130 of the slide 13. It surrounds the head 115 of the sleeve 11 and comes to lie against it.

Inside the recess 110 of the sleeve 11, in addition to the means 111 described above, there is a tracer 9 whose rod 90, which is constantly returned to an extended position by a spring 91, extends partly into the vicinity of the head 115 of the sleeve.

Therefore, when the slide 13 is moved upwardly, it repels the rod 90. This movement is recorded by the tracer, which is associated with adequate electronics, as being a sign of proper functioning of the device. On the contrary, if no movement is recorded by the tracer this means that the slide 13 is blocked. In this case, the electronics associated with the tracer can control stoppage of the device and even of the installation in which it is integrated.

FIGS. 3 to 5 shows substantially the same device as in FIG. 1.

With reference to FIG. 3, the device is hung from the lower end of the rod 81 of a cylinder 8 of vertical axis Z-Z′. It acts as sliding means to move the device 1 in the direction of the egg to be treated.

This cylinder may be mechanically, electrically or air operated.

Its body 81 is secured to a support S secured to the injection installation.

It may be a single-acting cylinder, whose return spring is not shown here.

Reference 810 is given to the piston of this cylinder which is in a magnetic material for example.

Detection means are fixed to the body 81 to detect the stroke of the rod 81 of the cylinder. In this case it is the stroke of piston 810 which is detected.

The detection means may consist of a digital or analogue position sensor. They may also be a tracer, an incremental sensor or an optical detection system.

For example sensors of the LVDT series by MICRO-EPSILON are fully suitable.

These detection means are linked to control and recording means (also called driving means in the foregoing) in the form of electronics (not shown) carried by the sleeve 11 for example and which, in relation to the detected stroke, are capable of driving the means 111 so as to deliver a different quantity of substance in relation to the detected stroke.

As can clearly be seen when comparing FIGS. 3 to 5 in which the device 1 is arranged vertically above eggs of different sizes, namely a medium-size egg OM (FIG. 3), a large egg (OG (FIG. 4) and a small egg OP (FIG. 5) placed in a dimple A, the stroke of the rod 81 of the cylinder is directly proportional to the size of the egg.

The device can therefore be designed so as to allocate different quantities of substance to be injected for different rod strokes. This provides best management of the volumes to be delivered.

Evidently, the quantity is inversely proportional to the size of the eggs.

Preferably, the technician in charge of the installation has configured the installation so that certain stroke values of the cylinder rod are associated with the four usual egg “calibres” (large, medium, small and very small), and a specific quantity of substance to be delivered is associated with each of these stroke values.

The device in FIGS. 6 to 8 is similar to the preceding device.

However, in this case, the cylinder 8 is a micro-cylinder and its rod 81 is linked to the device via a slide 14. Also, a second tube 16 of larger diameter is fixed on the support S along axis Z-Z′, in which tube the rod 81 and the slide 14 are inserted. A helical spring 15 is wedged between the upper end of the slide 14 and the lower end of the tube 16.

This solution, in which some of the forces are transferred to the spring 16, allows a smaller-sized cylinder to be used which allows more accurate management of the pressure applied to the egg.

Detection means 8′ are fixed to the tube 16 to detect displacement of the slide 14. Here it is the stroke of a collar 140 forming a piston which is detected.

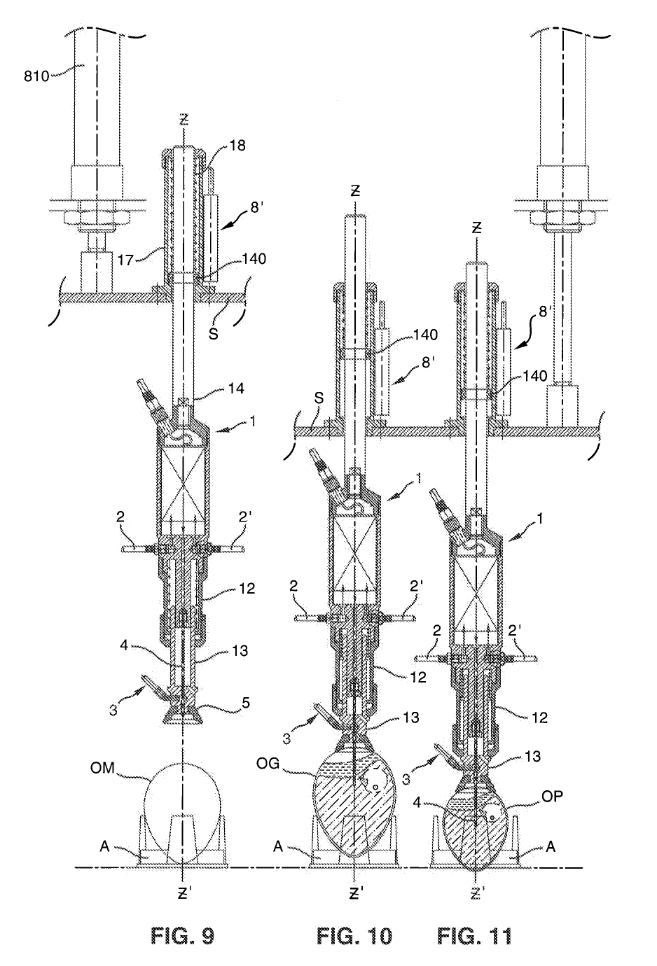

Finally, with reference to FIGS. 9 to 11, the support S carries a tube 17 which extends upwardly along Z-Z′, opposite the device 1.

A slide 14, at whose end the device 1 is attached, passes through it. This slide 14 also carries a peripheral collar 140 forming a piston against which a spiral spring 18 is wedged.

Here the support S is vertically mobile in the direction of the eggs to be treated.

Therefore it is lowered during a stroke so that the flexible suction cup 5 comes to bear against the egg to be treated, and the slide 13 moves upwards inside the skirt 12 as far as the adjustable abutment 120 (see FIG. 10).

This solution provides better rigidity and better guiding of the injection device.

This system is of interest since it allows the vertical lowering and raising of a plurality of injection devices using one same actuator, providing savings in equipment, simple assembly and cabling.

1. An injection device to inject at least one fluid substance into an egg, of the type comprising an injector body which is provided with a projecting needle to pierce and inject said substance into the amniotic liquid of said egg and/or into the embryo contained in said egg, this body being linked to external supply means of this substance, characterized by the fact that in said body drivable means are integrated to expel towards said needle one or more adjustable, variable and parameterizable quantities of substance derived from said supply means.

2. A device according to claim 1, characterized by the fact that said drivable means consist of a variable volume, electric micro-pump.

3. A device according to claim 1, characterized by the fact that said drivable means consist of a miniature solenoid valve.

4. A device according to claim 1, characterized by the fact that said body contains a cavity to house said means.

5. A device according to claim 1, characterized by the fact that the body is connected to external means supplying at least two substances, so as to allow the successive or simultaneous injection of these substances.

6. A device according to claim 1, characterized by the fact that said body is provided with electronic means to drive said expelling means.

7. A device according to claim 1, characterized by the fact that said body comprises a slide which longitudinally surrounds said needle and is mobile between two end positions, namely a first position—called rest position—in which it masks the entire length of said needle, and a second position—called retracted position—in which it comes to abut said body thereby freeing at least part of said needle.

8. A device according to claim 7, characterized by the fact that said body comprises an adjustable abutment whose positioning is used to cause a variation in the penetration length of the needle into said egg.

9. A device according to claim 7, characterized by the fact that said body comprises a sensor controlling the functioning of the slide.

10. A device according to claim 7, characterized by the fact that said slide is provided with a flexible suction cup able to follow the contour of the egg to block it in injection position.

11. A device according to claim 7, characterized by the fact that said slide is linked to means supplying a disinfectant product.

12. An installation to inject at least one fluid substance into eggs, characterized by the fact that it comprises a plurality of devices according to claim 1.

13. An installation according to claim 12, wherein the eggs to be treated are positioned in dimpled supports arranged one after the other on conveying means, characterized by the fact that it comprises at least one group of devices aligned crosswise relative to the direction of travel of said conveying means, their mutual spacing being identical to the distance separating two neighbouring dimples of said supports in the transverse direction.
